(19) United States
(12) Patent Application Publication
(10) Pub. No.: US 2008/0200623 A1
(43) Pub. Date: Aug. 21, 2008

(54) Polymerization Process

(75) Inventors: Matthias Weismantel, Jossgrund (DE); Rudiger Funk, Niedernhausen (DE); Dominicus van Esbroeck, Wouse Plantage (NL); Karl J. Possemiers, Schoten (BE); Ronny De Kaey, Vremde (BE); Leo Van Miert, Kapellen (BE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: BASF SE, Ludwigshafen (DE)

(21) Appl. No.: 12/065,129

(22) PCT Filed: Aug. 31, 2006
(86) PCT No.: PCT/EP2006/065844

§ 371 Date: Feb. 28, 2008

(30) Foreign Application Priority Data
Sep. 7, 2005 (DE) 10 2005 042 607.7

(51) Int. Cl. C08F 2/01; C08F 2/40; B01J 19/00

(52) U.S. Cl. 526/61; 526/82; 526/83; 422/131

(57) ABSTRACT

The invention relates to a process for preparing water-absorbing polymer particles, comprising the inertization of monomer solutions, wherein the monomer solution, based on the dissolved monomer, comprises from 0.001 to 0.016% by weight of at least one polymerization inhibitor and at least 50% by volume of the inert gas used to inertize the monomer solution is transferred into the polymerization reactor together with the inertized monomer solution, and also to apparatus for performing the process.

The present invention relates to a process for preparing water-absorbing polymer particles, comprising the inertization of low-stabilization monomer solutions, and also apparatus for performing the process.

Further embodiments of the present invention can be taken from the claims, the description and the examples. It is evident that the features of the inventive subject-matter which have been mentioned above and are yet to be illustrated below can be used not only in the combination specified in each case but also in other combinations without leaving the scope of the invention.

Water-absorbing polymers are especially polymers of (co)polymerized hydrophilic monomers, graft (co)polymers of one or more hydrophilic monomers on a suitable graft base, crosslinked cellulose ethers or starch ethers, crosslinked carboxymethylcellulose, partly crosslinked polyalkylene oxide or natural products swellable in aqueous liquids, for example guar derivatives, preference being given to water-absorbing polymers based on partly neutralized acrylic acid. Such polymers, as products which absorb aqueous solutions, are used to produce diapers, tampons, sanitary napkins and other hygiene articles, but also as water-retaining agents in market gardening.

The preparation of water-absorbing polymers is described, for example, in the monograph “Modern Superabsorbent Polymer Technology”, F. L. Buchholz and A. T. Graham, Wiley-VCH, 1998, or in Ullmann's Encyclopedia of Industrial Chemistry, 6th Edition, Volume 35, pages 73 to 103. The preferred preparation process is solution or gel polymerization. In this technology, a monomer mixture is first prepared and is neutralized batchwise and then transferred to a polymerization reactor, or is initially charged actually within the polymerization reactor. In the batchwise or continuous process which follows, the reaction proceeds to the polymer gel which, in the case of a stirred polymerization, is already in comminuted form. The polymer gel is subsequently dried, ground and sieved, and then transferred to further surface treatment.

A continuous polymerization process is the basis, for example, of WO-A-01/38402, in which the aqueous monomer solution together with the initiator and the inert gas is fed continuously to a mixing kneader having at least two axially parallel-rotating shafts.

Continuous gel polymerizations are also known from WO-A-03/004237, WO-A-03/022896 and WO-A-01/016197.

Before the polymerization, the monomer solution is freed of residual oxygen since oxygen inhibits free-radical polymerization and influences the polymerization reaction. A very substantial removal of the dissolved oxygen before and during the polymerization prevents inhibition or the termination of the polymerization reaction and, especially in continuous preparation processes, enables them to be initiated and the polymerization to be run in a controlled manner and hence the preparation of the desired water-absorbing polymers. There has therefore been no shortage of attempts in the past to provide processes and/or apparatus with which the dissolved oxygen can be removed from the monomer solutions. Typically, these processes are based on the flushing of the monomer solution with inert gas and the removal of the gas phase enriched with oxygen. In the inertization, the inert gas is usually passed in countercurrent through the monomer solution. Good mixing can be achieved, for example, with nozzles, static or dynamic mixers or bubble columns.

DE-A199 38 574 describes a typical bubble column, as used for inertizing monomer solutions. According to the application, the inertization is supported by additional mixer tools in the bubble column and the oxygen content of the inertized monomer solution is monitored.

An example of an inertization in cocurrent is disclosed by DE-A35 40 994. According to the application, the inert gas is sucked into the monomer solution by means of a water-jet pump.

A common feature of all processes is that relatively large amounts of inert gas are required and that the apparatus used becomes blocked easily owing to the high polymerization tendency of the inertized monomer solution, especially in the case of prolonged contact times between inert gas and monomer solution. According to DE-A-35 40 994, the contact time should therefore be restricted to a maximum of 20 seconds (page 11, paragraph 2).

EP-A-1 097 946 points out once again that the inert gas enriched with oxygen has to be removed before the polymerization. For this purpose, the application proposes various processes, for example degassing with ultrasound (page 9, lines 34 to 42).

EP-A-0 827 753 teaches the preparation of porous water-absorbing polymers. To pre-pare the porous polymers, a monomer solution foamed with a large amount of inert gas is polymerized. Inevitably, some inert gas somewhat enriched with oxygen passes here into the polymerization reactor.

All processes known from the prior art for the inertization of the monomer solution are generally based on a comparatively high level of apparatus demands. The inertization of the monomer solution usually constitutes a dedicated process step. Furthermore, it also requires an offgas line, via which the gas mixture somewhat enriched with oxygen is removed. In addition to the high level of apparatus demands, the required amount of inert gas constitutes a cost factor. A disadvantage is found to be the liability of the apparatus to faults, since the removal of the oxygen inhibitor readily allows the occurrence of premature polymerization in the apparatus itself or in the offgas line.

WO-A-03/051940 discloses the preparation of particularly low-discoloration water-absorbing polymer particles. According to the application, low-stabilization aqueous partly neutralized acrylic acid solutions are polymerized. Owing to the relatively low stabilization, the polymerization tendency of the monomer solution is increased correspondingly.

It was an object of the present invention of the present invention to provide a process for preparing water-absorbing polymer particles with only low discoloration, if any, the polymerization tendency being reduced during the inertization.

It was a further object of the present invention to provide an improved process for pre-paring water-absorbing polymer particles which optimally utilizes the inert gas used for the inertization and has low liability to faults.

Moreover, the process according to the invention should also be suitable for a continuous polymerization.

The object is achieved by a process for preparing water-absorbing polymer particles by inertizing a monomer solution and transferring the inertized monomer solution to a polymerization reactor, wherein the monomer solution, based on the dissolved monomer, comprises from 0.001 to 0.016% by weight of at least one polymerization inhibitor and at least 50% by volume of the inert gas used to inertize the monomer solution is transferred into the polymerization reactor together with the inertized monomer solution.

Inertization and polymerization are preferably carried out continuously.

The content of polymerization inhibitor, based on the dissolved polymer, is preferably from 0.001 to 0.013% by weight, more preferably from 0.003 to 0.007% by weight, most preferably from 0.004 to 0.006% by weight. Suitable polymerization inhibitors are all polymerization inhibitors which can inhibit and/or delay free-radical polymerization and have sufficient solubility.

“Delay the polymerization” means that the polymerization inhibitor reacts with a radical to give a radical with lower reactivity than a monomer radical.

“A sufficient solubility” means that the polymerization inhibitor is soluble in the desired amount in the monomer solution.

Suitable inert gases are all inert gases which cannot intervene in free-radical reactions, for example nitrogen, argon, steam. The preferred inert gas is nitrogen. It will be appreciated that the term “inert gas” also comprises inert gas mixtures.

The inert gas should preferably have maximum purity. For example, nitrogen having a nitrogen content of preferably at least 99% by volume, more preferably at least 99.9% by volume, most preferably at least 99.99% by volume may be used.

The inert gas is fed in via one or more inlets. The inert gas feeds may be arranged in an annular manner around the monomer line.

The inert gas used for inertization is subsequently transferred into the polymerization reactor preferably to an extent of at least 80%, more preferably to an extent of at least 90%, most preferably fully, together with the monomer solution.

The volume ratio of inert gas to monomer solution is preferably from 0.01 to 10, more preferably from 0.05 to 7, most preferably from 0.1 to 1.5.

The residence time of the monomer solution between inert gas feed and polymerization is preferably from 1 to 120 seconds, more preferably from 5 to 60 seconds, most preferably from 10 to 30 seconds.

The viscosity of the monomer solution at 15° C. is preferably from 5 to 200 mPas, more preferably from 10 to 100 mPas, most preferably from 20 to 50 mPas, the viscosity being measured with a Brookfield viscometer (spindle 2, 100 rpm).

The monomer concentration in the monomer solution is preferably from 10 to 80% by weight, more preferably from 20 to 60% by weight, most preferably from 30 to 50% by weight.

The monomer solution comprises at least one monoethylenically unsaturated monomer, preferably acrylic acid and/or salts thereof. The proportion of acrylic acid and/or salts thereof in the total amount of monomer is preferably at least 50 mol %, more preferably at least 90 mol %, most preferably at least 95 mol %.

In a preferred embodiment of the present invention, the inert gas is metered in via a Venturi tube.

A Venturi tube is a tube constriction of restricted length, in which the pressure drop can is converted substantially reversibly to kinetic energy. To this end, the cross-sectional area F₁ is reduced to the cross-sectional area F₂ over the distance L₁ (narrowing zone), the cross-sectional area F₂ is kept constant over the distance L₂ (constriction zone) and the cross-sectional area F₂ is then widened again to the cross-sectional area F₁ over the distance L₃ (diffuser). The cross-sectional area F₁ is greater than the cross-sectional area F₂ and the length L₃ is greater than the length L₁.

The inert gas is metered in preferably in the region of the distance L₂ with the cross-sectional area F₂.

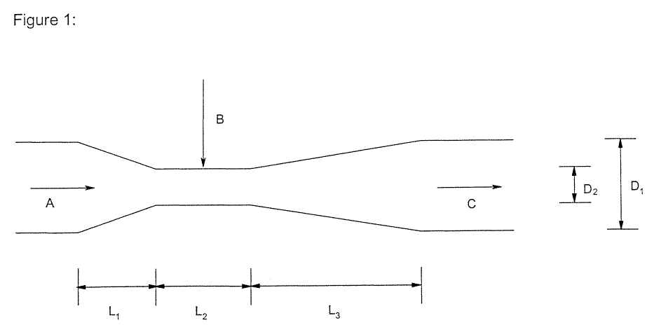

FIG. 1 shows a typical Venturi tube, the reference symbols being defined as follows:

A: monomer solution before inert gas metering
B: inert gas feed
C: monomer solution and inert gas
L₁: narrowing zone
L₂: constriction zone
L₃: diffuser
D₁: diameter of the pipeline
D₂: diameter of the constriction zone

The optimal design of a Venturi tube is known per se to those skilled in the art. The Venturi tube is preferably designed such that the pressure in the region of the distance L₂ is less than the ambient pressure (suction conveyance) and/or the flow in the region of the distance L₂ is turbulent, where the Reynolds number should be at least 1000, preferably at least 2000, more preferably at least 3000, most preferably at least 4000, and typically less than 10 000 000.

When a Venturi tube is used, a lower volume ratio of inert gas to monomer solution can be selected, preferably from 0.01 to 7, more preferably from 0.05 to 5, most preferably from 0.12 to 0.5.

The polymerization tendency can be reduced further when the connection between inert gas feed and polymerization reactor has at least partly, preferably at least to an extent of 50% of the surface area, more preferably as fully as possible in construction terms, a material surface which has a contact angle for water of at least 60°, preferably at least 900, more preferably at least 100°.

The contact angle is a measure of the wetting behavior and can be measured by customary methods, preferably according to DIN 53900.

Suitable materials with appropriate wetting behavior are polyethylene, polypropylene, polyester, polyamide, polytetrafluoroethylene, polyvinyl chloride, epoxy resins and silicone resins. Very particular preference is given to polypropylene.

The water-absorbing polymers are obtained, for example, by polymerization of a monomer solution comprising
a) at least one ethylenically unsaturated acid-functional monomer,
b) at least one crosslinker,
c) if appropriate one or more ethylenically and/or allylically unsaturated monomers copolymerizable with the monomer a), and
d) if appropriate one or more water-soluble polymers onto which the monomers a), b) and if appropriate c) can be at least partly grafted.

Suitable monomers a) are, for example, ethylenically unsaturated carboxylic acids, such as acrylic acid, methacrylic acid, maleic acid, fumaric acid and itaconic acid, or derivatives thereof, such as acrylamide, methacrylamide, acrylic esters and methacrylic esters. Particularly preferred monomers are acrylic acid and methacrylic acid. Very particular preference is given to acrylic acid.

The monomers a), especially acrylic acid, comprise preferably up to 0.016% by weight of a hydroquinone monoether. Preferred hydroquinone monoethers are hydroquinone monomethyl ether (MEHQ) and/or tocopherols.

Tocopherol refers to compounds of the following formula:

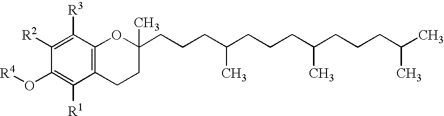

where R¹ is hydrogen or methyl, R² is hydrogen or methyl, R³ is hydrogen or methyl and R⁴ is hydrogen or an acyl radical having from 1 to 20 carbon atoms.

Preferred R⁴ radicals are acetyl, ascorbyl, succinyl, nicotinyl and other physiologically tolerable carboxylic acids. The carboxylic acids may be mono-, di- or tricarboxylic acids.

Preference is given to alpha-tocopherol where R¹=R²=R³=methyl, especially racemic alpha-tocopherol. R¹ is more preferably hydrogen or acetyl. Especially preferred is RRR-alpha-tocopherol.

The monomer solution comprises preferably not more than 130 ppm by weight, more preferably not more than 70 ppm by weight, preferably not less than 10 ppm by weight, more preferably not less than 30 ppm by weight and especially about 50 ppm by weight of hydroquinone monoether, based in each case on acrylic acid, with acrylic acid salts being counted as acrylic acid. For example, the monomer solution can be prepared using acrylic acid having an appropriate hydroquinone monoether content.

The crosslinkers b) are compounds having at least two polymerizable groups which can be free-radically polymerized into the polymer network. Suitable crosslinkers b) are, for example, ethylene glycol dimethacrylate, diethylene glycol diacrylate, allyl methacrylate, trimethylolpropane triacrylate, triallylamine, tetraallyloxyethane, as described in EP-A-0 530 438, di- and triacrylates, as described in EP-A 0 547 847, EP-A 0 559 476, EP-A 0 632 068, WO 93/21237, WO 03/104299, WO 03/104300, WO 03/104301 and DE-A 103 31 450, mixed acrylates which, as well as acrylate groups, comprise further ethylenically unsaturated groups, as described in DE-A 103 31 456 and WO 04/013064, or crosslinker mixtures as described, for example, in DE-A 195 43 368, DE-A 196 46 484, WO 90/15830 and WO 02/32962.

Suitable crosslinkers b) include in particular N,N′-methylenebisacrylamide and N,N′-methylenebismethacrylamide, esters of unsaturated mono- or polycarboxylic acids of polyols, such as diacrylate or triacrylate, for example butanediol diacrylate, butanediol dimethacrylate, ethylene glycol diacrylate, ethylene glycol dimethacrylate and also trimethylolpropane triacrylate and allyl compounds, such as allyl (meth)acrylate, triallyl cyanurate, diallyl maleate, polyallyl esters, tetraallyloxyethane, triallylamine, tetraallylethylenediamine, allyl esters of phosphoric acid and also vinylphosphonic acid derivatives as described, for example, in EP-A 0 343 427. Suitable crosslinkers b) further include pentaerythritol diallyl ether, pentaerythritol triallyl ether, pentaerythritol tetraallyl ether, polyethylene glycol diallyl ether, ethylene glycol diallyl ether, glycerol diallyl ether, glycerol triallyl ether, polyallyl ethers based on sorbitol, and also ethoxylated variants thereof. In the process of the invention, it is possible to use di(meth)acrylates of polyethylene glycols, the polyethylene glycol used having a molecular weight between 300 and 1000.

However, particularly advantageous crosslinkers b) are di- and triacrylates of 3- to 15-tuply ethoxylated glycerol, of 3- to 15-tuply ethoxylated trimethylolpropane, of 3- to 15-tuply ethoxylated trimethylolethane, especially di- and triacrylates of 2- to 6-tuply ethoxylated glycerol or of 2- to 6-tuply ethoxylated trimethylolpropane, of 3-tuply propoxylated glycerol or of 3-tuply propoxylated trimethylolpropane, and also of 3-tuply mixed ethoxylated or propoxylated glycerol or of 3-tuply mixed ethoxylated or propoxylated trimethylolpropane, of 15-tuply ethoxylated glycerol or of 15-tuply ethoxylated trimethylolpropane, and also of 40-tuply ethoxylated glycerol, of 40-tuply ethoxylated trimethylolethane or of 40-tuply ethoxylated trimethylol propane.

Very particularly preferred crosslinkers b) are polyethoxylated and/or -propoxylated glycerols which have been esterified with acrylic acid or methacrylic acid to di- or triacrylates, as described, for example, in WO 03/104301. Di- and/or triacrylates of 3- to 10-tuply ethoxylated glycerol are particularly advantageous. Very particular preference is given to di- or triacrylates of 1- to 5-tuply ethoxylated and/or propoxylated glycerol. The triacrylates of 3- to 5-tuply ethoxylated and/or propoxylated glycerol are most preferred. These are notable for particularly low residual levels (typically below 10 ppm by weight) in the water-absorbing polymer and the aqueous extracts of the water-absorbing polymers produced therewith have an almost unchanged surface tension (typically not less than 0.068 N/m) compared with water at the same temperature.

The amount of crosslinker b) is preferably from 0.01 to 1% by weight, more preferably from 0.05% to 0.5% by weight, most preferably from 0.1 to 0.3% by weight, based in each case on the monomer a).

Examples of ethylenically unsaturated monomers c) which are copolymerizable with the monomers a) are acrylamide, methacrylamide, crotonamide, dimethylaminoethyl methacrylate, dimethylaminoethyl acrylate, dimethylaminopropyl acrylate, diethylaminopropyl acrylate, dimethylaminobutyl acrylate, dimethylaminoethyl methacrylate, diethylaminoethyl methacrylate, dimethylaminoneopentyl acrylate and dimethylaminoneopentyl methacrylate.

Useful water-soluble polymers d) include polyvinyl alcohol, polyvinylpyrrolidone, starch, starch derivatives, polyglycols or polyacrylic acids, preferably polyvinyl alcohol and starch.

For optimal action, the preferred polymerization inhibitors require dissolved oxygen. Typically, the monomer solutions are substantially freed of oxygen before the polymerization (inertization), for example by means of flowing an inert gas, preferably nitrogen, through them. This distinctly weakens the action of the polymerization inhibitors. The oxygen content of the monomer solution is preferably lowered to less than 1 ppm by weight and more preferably to less than 0.5 ppm by weight before the polymerization.

The preparation of a suitable base polymer and also further suitable hydrophilic ethylenically unsaturated monomers d) are described in DE-A 199 41 423, EP-A 0 686 650, WO 01/45758 and WO 03/104300.

Water-absorbing polymers are typically obtained by addition polymerization of an aqueous monomer solution and, if desired, subsequent comminution of the hydrogel. Suitable preparation methods are described in the literature. Water-absorbing polymers are obtainable, for example, by
gel polymerization in the batch process or tubular reactor and subsequent comminution in meat grinder, extruder or kneader (EP-A-0 445 619, DE-A-19 846 413)
addition polymerization in kneader with continuous comminution by contrarotatory stirring shafts for example (WO-A-01/38402)
addition polymerization on belt and subsequent comminution in meat grinder, extruder or kneader (DE-A-38 25 366, U.S. Pat. No. 6,241,928)
emulsion polymerization, which produces bead polymers having a relatively narrow gel size distribution (EP-A-0 457 660)
in situ addition polymerization of a woven fabric layer which, usually in a continuous operation, has previously been sprayed with aqueous monomer solution and subsequently been subjected to a photopolymerization (WO-A-02/94328, WO-A-02/94329).

The reaction is preferably carried out in a kneader, as described, for example, in WO 01/38402, or on a belt reactor, as described, for example, in EP-A 0 955 086.

Neutralization can also be carried out partly after the polymerization, at the hydrogel stage. It is therefore possible to neutralize up to 40 mol %, preferably from 10 to 30 mol % and more preferably from 15 to 25 mol % of the acid groups before the polymerization by adding a portion of the neutralizing agent actually to the monomer solution and setting the desired final degree of neutralization only after the polymerization, at the hydrogel stage. The monomer solution can be neutralized by mixing in the neutralizing agent. The hydrogel may be comminuted mechanically, for example by means of a meat grinder, in which case the neutralizing agent can be sprayed, sprinkled or poured on and then carefully mixed in. To this end, the gel mass obtained can be repeatedly ground in the meat grinder for homogenization. Neutralization of the monomer solution to the final degree of neutralization is preferred.

The neutralized hydrogel is then dried with a belt or drum dryer until the residual moisture content is preferably below 15% by weight and especially below 10% by weight, the water content being determined by EDANA (European Disposables and Nonwovens Association) recommended test method No. 430.2-02 “Moisture content”. If desired, drying can also be carried out using a fluidized bed dryer or a heated plowshare mixer. To obtain particularly white products, it is advantageous to dry this gel while ensuring rapid removal of the evaporating water. To this end, the dryer temperature must be optimized, the air feed and removal has to be controlled, and sufficient venting must be ensured in each case. The higher the solids content of the gel, the simpler the drying, by its nature, and the whiter the product. The solids content of the gel before the drying is therefore preferably between 30% and 80% by weight. It is particularly advantageous to vent the dryer with nitrogen or another nonoxidizing inert gas. If desired, however, it is possible simply just to lower the partial pressure of the oxygen during the drying in order to prevent oxidative yellowing processes. In general, though, adequate venting and removal of the water vapor also still lead to an acceptable product. A very short drying time is generally advantageous with regard to color and product quality.

The dried hydrogel is preferably ground and sieved, useful grinding apparatus typically including roll mills, pin mills or swing mills. The particle size of the sieved, dry hydrogel is preferably below 1000 μm, more preferably below 900 μm and most preferably below 800 μm, and preferably above 100 μm, more preferably above 150 μm and most preferably above 200 μm.

Very particular preference is given to a particle size (sieve cut) of from 106 to 850 μm. The particle size is determined according to EDANA (European Disposables and Nonwovens Association) recommended test method No. 420.2-02 “Particle size distribution”.

The base polymers are then preferably surface postcrosslinked. Postcrosslinkers suitable for this purpose are compounds comprising two or more groups capable of forming covalent bonds with the carboxylate groups of the hydrogel. Suitable compounds are, for example, alkoxysilyl compounds, polyaziridines, polyamines, polyamidoamines, di- or polyglycidyl compounds, as described in EP-A-0 083 022, EP-A-0 543 303 and EP-A-0 937 736, di- or polyfunctional alcohols, as described in DE-C-33 14 019, DE-C-35 23 617 and EP-A-0 450 922, or β-hydroxyalkylamides, as described in DE-A-102 04 938 and U.S. Pat. No. 6,239,230.

In addition, DE-A-40 20 780 describes cyclic carbonates, DE-A-1 98 07 502 2-oxazolidone and its derivatives, such as 2-hydroxyethyl-2-oxazolidone, DE-A-1 98 07 992 bis- and poly-2-oxazolidinones, DE-A-198 54 573 2-oxotetrahydro-1,3-oxazine and its derivatives, DE-A-198 54 574 N-acyl-2-oxazolidones, DE-A-102 04 937 cyclic ureas, DE-A-103 34 584 bicyclic amide acetals, EP-A-1 199 327 oxetanes and cyclic ureas and WO-A-03/031482 morpholine-2,3-dione and its derivatives, as suitable surface postcrosslinkers.

The postcrosslinking is typically carried out in such a way that a solution of the surface postcrosslinker is sprayed onto the hydrogel or onto the dry base polymer powder. After the spraying, the polymer powder is dried thermally, and the crosslinking reaction may take place either before or during drying.

The spraying with a solution of the crosslinker is preferably carried out in mixers having moving mixing implements, such as screw mixers, paddle mixers, disk mixers, plowshare mixers and shovel mixers. Particular preference is given to vertical mixers and very particular preference to plowshare mixers and shovel mixers. Suitable mixers are, for example, Lödige® mixers, Bepex® mixers, Nauta® mixers, Processall® mixers and Schugi® mixers.

The thermal drying is preferably carried out in contact dryers, more preferably shovel dryers and most preferably disk dryers. Suitable dryers are, for example, Bepex® dryers and Nara® dryers. It is also possible to use fluidized bed dryers.

The drying can be effected in the mixer itself, by heating the jacket or blowing in warm air. It is equally possible to use a downstream dryer, for example a tray dryer, a rotary tube oven or a heatable screw. It is also possible, for example, to utilize an azeotropic distillation as a drying process.

Preferred drying temperatures are in the range from 50 to 250° C., preferably in the range from 50 to 200° C. and more preferably in the range from 50 to 150° C. The preferred residence time at this temperature in the reaction mixer or dryer is below 30 minutes and more preferably below 10 minutes.

The process according to the invention enables the economically viable continuous preparation of postcrosslinked water-absorbing polymer particles. The monomer solutions used can be inertized reliably with little inert gas. The polymerization tendency of the inertized monomer solution upstream of the reactor is low.

The present invention further provides an apparatus for carrying out the process according to the invention, comprising

i) a polymerization reactor,
ii) at least one inlet to the polymerization reactor i) and
iii) at least one inlet into the inlet ii),
where the inner surface of the inlet ii) between polymerization reactor i) and inlet iii) at least partly has a contact angle for water of at least 60°, preferably at least 900, more preferably at least 100°.

The contact angle is a measure of the wetting behavior and can be measured by customary methods, preferably according to DIN 53900.

Suitable materials with corresponding wetting behavior are polyethylene, polypropylene, polyester, polyamide, polytetrafluoroethylene, polyvinyl chloride, epoxy resins and silicone resins. Very particular preference is given to polypropylene.

The length of the inlet ii) between polymerization reactor i) and inlet iii) is preferably from 0.5 to 20 m, more preferably from 1 to 10 m, most preferably from 1.5 to 5 m. The cross-sectional area of the inlet ii) is preferably from 10 to 1000 cm², more preferably from 25 to 500 cm², most preferably from 50 to 200 cm². The inlet ii) preferably has a circular cross section.

In a preferred embodiment, the inlet iii) encircles the inlet ii), preferably at right angles to the flow direction. The common intermediate wall between inlet iii) and inlet ii) has holes through which inert gas can flow into the inlet ii) and thus into the monomer solution. The number of holes is typically from 5 to 500, preferably from 10 to 100, more preferably from 20 to 50. The hole diameter should be selected such that the rate of discharge of the inert gas is typically at least 0.1 m/s, preferably at least 0.5 m/s, more preferably at least 1 m/s, most preferably at least 1.5 m/s. Rates of discharge above 10 m/s are typically not required.

The holes are typically arranged uniformly alongside one another. The axis of the drill-holes preferably points towards the conveying direction of the monomer solution, for example with an angle of from 100 to 140°, which promotes the mixing.

In a particularly preferred embodiment, the feed iii) is designed as an intermediate section of the inlet ii) and can be inserted between a flange connection.

In a further preferred embodiment, the inlet ii) is designed as a Venturi tube at the connection with the inlet iii).

The Venturi tube has, preferably in the region of the constriction zone, one or more holes through which inert gas can flow into the monomer solution. The number of holes is typically from 1 to 20, preferably from 1 to 10, more preferably from 1 to 5. The hole diameter should be selected such that the rate of discharge of the inert gas is typically at least 0.05 m/s, preferably at least 0.1 m/s, more preferably at least 0.2 m/s, most preferably at least 0.3 m/s. Rates of discharge above 1 m/s are typically not required owing to the turbulent flow.

The cross-sectional area of the inlet ii) in the constriction zone is reduced by at least 20%, preferably at least 30%, more preferably at least 40%, most preferably at least 50%.

The ratio of length of the constriction zone L₂ to length of the narrowing zone L₁ is preferably from 0.5 to 20, more preferably from 1 to 10, most preferably from 2 to 5, and/or the ratio of length of the constriction zone L₂ to length of the diffuser L₃ is preferably from 0.1 to 5, more preferably from 0.5 to 2.5, most preferably from 1 to 2.

The apparatus is preferably free of dead spaces and the surfaces should have minimum roughness.

Dead spaces are sections of the apparatus in which the average residence time is increased in the course of operation as intended.

The inventive apparatuses are outstandingly suitable for inertizing monomer solutions. Especially owing to their specific inner surface, the polymerization tendency is low.

### EXAMPLES

### Example 1

17 250 kg per hour (14 7801/h) of a monomer solution comprising 31.4% by weight of sodium acrylate, 8.0% by weight of acrylic acid, 0.0016% by weight of hydroquinone monomethyl ether and 0.65% by weight of trimethylolpropane were inertized with 3 kg per hour (2400 l/h) of nitrogen. The viscosity of the monomer solution at 15° C. was 28 mPas. The surface tension of the monomer solution was 0.04 N/m.

Inertization was effected using a 93.2 cm-long Venturi tube (FIG. 1), in which the pipeline narrowed from a diameter of 9 cm to 3.6 cm over a distance of 8.4 cm (zone L₁), retained the diameter of 3.6 cm over a distance of 27.6 cm (zone L₂) and widened back from a diameter of 3.6 cm to 9 cm over a distance of 57 cm (zone L₃).

The inert gas (>99% by volume of nitrogen) was fed via two opposite inlets in the middle of the constriction zone (zone L₂). The feeds each had an internal diameter of 5 mm. The gas/liquid mixture was transferred fully into the polymerization reactor.

The distance between nitrogen feed and polymerization reactor was 2 m. The residence time of the gas/liquid mixture in the line was approx. 3 seconds.

Inertization and polymerization ran without disruption.

### Example 2

17 250 kg per hour (14 780 l/h) of a monomer solution comprising 31.4% by weight of sodium acrylate, 8.0% by weight of acrylic acid, 0.0016% by weight of hydroquinone monomethyl ether and 0.65% by weight of trimethylolpropane were inertized with 8 kg per hour (6400 l/h) of nitrogen. The viscosity of the monomer solution at 10-15° C. was 28-46 mPas. The surface tension of the monomer solution was 0.04 N/m.

The monomer line had a diameter of 9 cm. A ring was inserted into the monomer line at right angles to the flow direction; the inner diameter of the ring corresponded to the outer diameter of the monomer line. The ring had an inner width of 13 mm.

The inert gas (>99% by volume of nitrogen) was fed to the monomer solution through 32 holes in the ring with a hole diameter of 1.8 mm. The holes were distributed uniformly and were aligned in the direction of the ring center. The gas/liquid mixture was transferred fully into the polymerization reactor.

The distance between nitrogen feed and polymerization reactor was 2 m. The residence time of the gas/liquid mixture in the line was approx. 3 seconds.

Inertization and polymerization ran without disruption.

Owing to the small amount of inert gas used for inertization, the monomer solution comprises more dissolved oxygen than is customary in the prior art. Possibly, this compensates for the lower content of hydroquinone monomethyl ether.

At the same time, the partial oxygen pressure in the gas phase is relatively high as a result. Since the gas phase is conveyed into the polymerization reactor together with the monomer solution, this oxygen is still available during the transport of the monomer solution into the polymerization reactor and reduces undesired polymerization upstream of the polymerization reactor. Owing to the large phase transfer surface in the course of transport, consumed dissolved oxygen can be replaced rapidly by diffusion from the gas phase. In the polymerization reactor, this diffusion is then suppressed considerably owing to the distinctly smaller phase transfer surface.

1. A process for preparing water-absorbing polymer particles by inertizing a monomer solution and transferring the inertized monomer solution to a polymerization reactor, wherein the monomer solution, based on dissolved monomer, comprises from 0.001 to 0.016% by weight of at least one polymerization inhibitors and at least 50% by volume of an inert gas used to inertize the monomer solution is transferred into the polymerization reactor together with the inertized monomer solution.

2. The process according to claim 1, wherein an inner surface of a connection between an inert gas feed and the polymerization reactor at least partly has a contact angle for water of at least 60°.

3. The process according to claim 1, wherein a volume ratio of the inert gas to the monomer solution is less than 10.

4. The process according to claim 1, wherein the inert gas is fed through a Venturi tube and the volume ratio of the inert gas to the monomer solution is from 0.01 to 7.

5. The process according to claim 1, wherein a residence time of the monomer solution between the inert gas feed and the polymerization reactor is from 1 to 120 seconds.

6. The process according to claim 1, wherein a viscosity of the monomer solution at 15° C. is from 5 to 200 mPas.

7. The process according to claim 1, wherein a monomer concentration in the monomer solution is from 10 to 80% by weight.

8. The process according to claim 1, wherein at least 50 mol % of monomers of the monomer solution are acrylic acid and/or salts thereof.

9. The process according to claim 1, wherein the inert gas comprises at least 99% by volume of nitrogen.

10. The process according to claim 1, wherein the monomer solution is polymerized in the polymerization reactor to give a hydrogel, dried, ground, and classified.

11. The process according to claim 10, wherein the classified polymer particles are surface postcrosslinked.

12. An apparatus for continuous polymerization, comprising
i) a polymerization reactor,
ii) at least one inlet to the polymerization reactor i), and
iii) at least one inlet into the inlet ii),
wherein an inner surface of the inlet ii) between the polymerization reactor i) and the inlet iii) at least partly has a contact angle for water of at least 60°.

13. The apparatus according to claim 12, wherein a length of the inlet ii) between the polymerization reactor i) and the inlet iii) is from 0.5 to 20 m.

14. The apparatus according to claim 12, wherein the inlet iii) encircles the inlet ii) and a common intermediate wall has holes.

15. The apparatus according to claim 14, wherein the common intermediate wall has from 5 to 500 holes.

16. The apparatus according to claim 12, wherein the inlet ii) is designed as a Venturi tube at a connection with the inlet iii), and the inlet iii) opens into a constriction zone of the Venturi tube.

17. The apparatus according to claim 16, wherein a cross-sectional area of the inlet ii) in the constriction zone is reduced by at least 20%.

18. The apparatus according to claim 16, wherein a ratio of length of a constriction zone L₂ to length of a narrowing zone L₁ is from 0.5 to 20 and/or a ratio of length of the constriction zone L₂ to length of a diffuser L₃ is from 0.1 to 5.

19. The apparatus according to claim 17 wherein a ratio of length of a constriction zone L₂ to length of a narrowing zone L₁ is from 0.5 to 20 and/or a ratio of length of the constriction zone L₂ to length of a diffuser L₃ is from 0.1 to 5.
